(19) United States
(12) Patent Application Publication
(10) Pub. No.: US 2026/0292004 A1
(43) Pub. Date: Sep. 24, 2026

(54) Method and Apparatus for Session Rule Report

(71) Applicant: Telefonaktiebolaget LM Ericsson, Stockholm (SE)

(72) Inventors: Wen Zhang, Shanghai (CN); Fuencisla Garcia Azorero, Madrid (ES); Yingjiao He, Shanghai (CN); Chunmiao Liu, Shanghai (CN)

(21) Appl. No.: 19/478,448

(22) PCT Filed: Apr. 25, 2024
(86) PCT No.: PCT/CN2024/089717

§ 371 Date: Oct. 24, 2025

(30) Foreign Application Priority Data
May 8, 2023 (WO) PCT/CN2023/092691

(51) Int. Cl. H04L 65/1083

(52) U.S. Cl. CPC H04L 65/1083

(57) ABSTRACT

Embodiments of the present disclosure provide methods and apparatuses for session rule report. A method performed by a policy control node may comprise send a first message comprising a session rule to a session management node. The session rule comprises one or more policy information elements comprising at least one of Authorized Session-Aggregate Maximum Bit Rate AMBR, or Authorized Default Quality of Service QoS. The method further comprises receiving a second message from the session management node. The second message comprises first information indicating at least one operation status of the at least one of the Authorized Session-AMBR, or the Authorized Default QoS information. The Authorized Session-AMBR and the Authorized Default Quality of Service QoS information may be associated with a protocol data unit session.

### TECHNICAL FIELD

The non-limiting and exemplary embodiments of the present disclosure generally relate to the technical field of communications, and specifically to method and apparatus for session rule report.

### BACKGROUND

This section introduces aspects that may facilitate a better understanding of the disclosure. Accordingly, the statements of this section are to be read in this light and are not to be understood as admissions about what is in the prior art or what is not in the prior art.

In a network such as fifth generation core network (5GC), a session management policy control service may perform provisioning, update and removal of session related policies and policy and charging control (PCC) rules by the policy control function (PCF) to the network function (NF) service consumer (e.g. session management function (SMF)). The session management policy control service can be used for charging control, policy control, application detection and control and/or access traffic steering, switching and splitting within a multiple access (MA) protocol data unit (PDU) session. The session management policy control service may apply to the cases where the SMF interacts with the PCF in a non-roaming scenario, the SMF interacts with a visited PCF (V-PCF) in a local breakout roaming scenario and a home SMF (H-SMF) interacts with a home PCF (H-PCF) in a home-routed scenario.

For example, in 5GC, a session rule may comprise policy information elements associated with PDU session. A session rule may be dynamically provisioned by the PCF to the SMF (i.e., there are only dynamic session rules). The encoding of the session rule data type is defined in clause 5.6.2.7 of 3rd Generation Partnership Project (3GPP) Technical Specification (TS) 29.512 V18.1.0, the disclosure of which is incorporated by reference herein in its entirety.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

As defined in clause 4.1.4.3.1 of 3GPP TS 29.512 V18.1.0, a session rule shall include a session rule identifier. A session rule may include at least one of authorized session aggregate maximum bit rate (AMBR), authorized default quality of service (QoS), reference to usage monitoring data, reference to Usage Monitoring Data for Non-3GPP access of MA PDU session, and reference to condition data.

As defined in clause 4.1.4.3.2 of 3GPP TS 29.512 V18.1.0, for session rules, the following applies: installation to provision the session rules, modification to modify the session rules, and removal to remove the session rules.

Table 5.6.2.7-1 of 3GPP TS 29.512 V18.1.0 shows a definition of type SessionRule as following.

TABLE 5.6.2.7-1
Definition of type SessionRule

| Attribute name | Data type | P | Cardinality | Description | Applicability |
|---|---|---|---|---|---|
| authSessAmbr | Ambr | C | 0 . . . 1 | Authorized Session-AMBR. | |
| | | | | (NOTE 1) | |
| authDefQos | AuthorizedDefault | C | 0 . . . 1 | Authorized default QoS | |
| | Qos | | | information. (NOTE 1) | |
| sessRuleId | string | M | 1 | Univocally identifies the | |
| | | | | session rule within a PDU | |
| | | | | session. | |
| refUmData | string | O | 0 . . . 1 | A reference to | UMC |
| | | | | UsageMonitoringData policy | |
| | | | | decision type. It is the umId | |
| | | | | described in clause 5.6.2.12 | |
| | | | | of 3GPP TS 29.512 | |
| | | | | V18.1.0. (NOTE 2) | |
| refCondData | string | O | 0 . . . 1 | A reference to the condition | |
| | | | | data. It is the condId described | |
| | | | | in clause 5.6.2.9 of 3GPP TS | |
| | | | | 29.512 V18.1.0. | |
| refUmN3gData | string | O | 0 . . . 1 | A reference to | UMC, |
| | | | | UsageMonitoringData policy | ATSSS |
| | | | | decision type to apply for | |
| | | | | Non-3GPP access. It is the | |
| | | | | umId described in | |
| | | | | clause 5.6.2.12 of 3GPP TS | |
| | | | | 29.512 V18.1.0. (NOTE 2) | |

(NOTE 1):
When the “subsDefQos” and “subsSessAmbr” are provided to the PCF, the PCF shall provide both “authSessAmbr” and the “authDefQos” attributes the first time the session rule is provisioned. In this case, the PCF shall ensure that a session rule enforced in the SMF contains the “authSessAmbr” and the “authDefQos” attributes.
(NOTE 2):
For a MA PDU session, if the “refUmN3gData” is omitted, the attribute “refUmData” contains the reference to the UsageMonitoringData policy decision to apply for both, 3GPP and Non-3GPP, accesses.

If session rule operation (such as installation or modification) failure happens, the SMF can report session rule failure in SmPolicyUpdateContextData as following Table 5.6.2.37-1 of 3GPP TS 29.512 V18.1.0.

TABLE 5.6.2.37-1
Definition of type SessionRuleReport

| | | | | | |
|---|---|---|---|---|---|
| Attribute name | Data type | P | Cardinality | Description | Applicability |

| | | | | |
|---|---|---|---|---|
| ruleIds | array(string) | M | 1 . . . N | Contains the identifier of the |
| | | | | affected session rule(s). |
| ruleStatus | RuleStatus | M | 1 | Indicates the status of the |
| | | | | session rule(s). |
| sessRuleFailureCode | SessionRuleFailureCode | C | 0 . . . 1 | Indicates the reason that the |
| | | | | session rule(s) is being reported. |
| | | | | It shall be included when the |
| | | | | NF service consumer reports |
| | | | | the enforcement failure of the |
| | | | | session rule(s). |

Clause 4.2.3.20 of 3GPP TS 29.512 V18.1.0 describes session rule error report as following.

If the “SessionRuleErrorHandling” feature is supported and the SMF receives one or more session rule(s) as defined in clause 4.2.6.3.1 of 3GPP TS 29.512 V18.1.0 but the validation of all the received session rules was unsuccessful, the SMF shall reject the request via an HTTP “400 Bad Request” status code and include in the corresponding response message the “sessRuleReports” attribute containing SessionRuleReport data structure(s) to report the failure for the affected session rule(s) within the ErrorReport data structure; otherwise, if the validation of some of the received session rules was unsuccessful, the SMF shall reply to the PCF with an HTTP “200 OK” status code and include in the corresponding response message the “sessRuleReports” attribute containing one or more SessionRuleReport data structure(s) to report the failure for the affected session rule(s) within the PartialSuccessReport data structure.

Within each SessionRuleReport instance, the SMF shall identify the failed session rule(s) by including their identifier(s) within the “ruleIds” attribute, identify the failure reason code by including a “sessRuleFailureCode” attribute, and include the session rule(s) status within the “ruleStatus” attribute containing a value as follows:
If the installation of one or more new session rule(s) (i.e. rules which were not previously successfully installed) fails, the SMF shall set the “ruleStatus” attribute value to “INACTIVE”.
If the modification of a currently provisioned session rule fails, the SMF shall retain the existing session rule as provisioned without any modification, unless the reason for the failure has an impact also on the existing session rule. The SMF shall report the modification failure to the PCF.

The removal of a session rule shall never fail, even if the related PDU session procedures with the UE fail. The SMF shall then retain information on the removal of the PDU session and conduct the necessary PDU session procedures with the UE when it is possible.

Depending on the value of the “sessRuleFailureCode” attribute, the PCF may decide whether retaining, re-installation, modification or removal of the old session rule, or any other action applies.

Clause 4.2.4.21 of 3GPP TS 29.512 V18.1.0 describes session rule error report as following.

If the “SessionRuleErrorHandling” feature is supported and if the installation of one or more session rules fails using the procedure as defined in clauses 4.2.2.1 or 4.2.4.1 of 3GPP TS 29.512 V18.1.0 or the PCF provisioned one or more session rules as defined in clause 4.2.3.1 of 3GPP TS 29.512 V18.1.0 but enforcement of the session Rule was unsuccessful (e.g. session-AMBR is rejected by the AMF in the roaming scenario, and the SMF determines that the PDU session is kept, the SMF shall include the “sessRuleReports” attribute for the affected session rules to report the failure within the SmPolicyUpdateContextData data structure. Within each SessionRuleReport instance, the SMF shall identify the failed session rule(s) by including the affected session rules within the “ruleIds” attribute, identify the failed reason code by including a “sessRuleFailureCode” attribute, and shall include rule status within the “ruleStatus” attribute with the value as described below.

If the installation of one or more new session rules fails, the SMF shall set the “ruleStatus” to INACTIVE.

The removal of a session rule shall not fail, even if the PDU session procedures with the UE fail. The SMF shall retain information on the removal and conduct the necessary PDU session procedures with the UE when it is possible.

If the modification of a currently provisioned session rule fails, the SMF shall retain the existing session rule as provisioned without any modification unless the reason for the failure has an impact also on the existing session rule. The SMF shall report the modification failure to the PCF.

NOTE: When the PCF receives “ruleStatus” set to INACTIVE, the PCF does not need to request the SMF to remove the inactive session rule.

Depending on the value of the “sessRuleFailureCode” attribute, the PCF may decide whether retaining the old session rule, re-installation, modification, removal of the session rule or any other action applies.

The policy control function may require a session rule report to know which policy information element or parameters in the session rule is successfully enforced (such as installed or modified) and/or which policy information element in the session rule is failed to be enforced when partial enforcement failure in the session rule happens. Then the policy control function can take an accurate policy according to the session rule report.

For example, during the enforcement of the session rule (e.g. during session modification/installation triggered by the PCF), it might occur that either the enforcement of the default QoS (fifth generation (5G) QoS identifier (5QI) and allocation and retention priority (ARP)) or the enforcement of the session AMBR fails, or both enforcements fail.

However, the SessionRuleFailureCode data type as described in Table 5.6.2.37-1 of 3GPP TS 29.512 V18.1.0 does not specify any of the enforcement errors mentioned above, and thus does not allow to differentiate the reason for the enforcement failure.

The existing session rule report for example as described in 3GPP TS 29.512 V18.1.0 only provides a session rule failure code which indicates the reason that the session rule(s) is being reported. The existing session rule report shall be included when the NF service consumer reports the enforcement failure of the session rule(s). There is no mechanism in the existing session rule report to indicate which policy information element in the session rule is successfully enforced (such as installed or modified) and/or which policy information element in the session rule is failed to be enforced when the partial enforcement failure in the session rule happens.

For example, according to clause 9.3.4.4 of 3GPP TS 38.413 V17.4.0, the PDU Session Resource Modify Response Transfer may comprise the following information element (IE)/group name: QoS Flow Failed to Add or Modify List (see Table 1), the disclosure of which is incorporated by reference herein in its entirety. It can see that radio access network (RAN) can accept session-AMBR but reject default QoS modification.

TABLE 1
PDU Session Resource Modify Response Transfer

| | | | | | | |
|---|---|---|---|---|---|---|
| | | | IE type and | Semantics | | Assigned |
| IE/Group Name | Presence | Range | reference | description | Criticality | Criticality |

| | | | |
|---|---|---|---|
| QoS Flow Failed to | O | QoS Flow | — |
| Add or Modify | | List with | |
| List(e.g. default QoS | | Cause | |
| flow QoS Flow | | 9.3.1.13 of | |
| Identifier (QFI)) | | 3GPP TS | |
| | | 38.413 | |
| | | V17.4.0 | |

If PCF wants to modify or install both session-AMBR and default QoS in one session rule, but RAN accepts the session-AMBR modification and rejects the default QoS modification, SMF cannot give the correct session rule report to PCF. The incomplete functionality may lead to wrong interpretation in the PCF of the error situation and consequently wrong policy determination.

To overcome or mitigate at least one of above mentioned problems or other problems, the embodiments of the present disclosure propose an improved solution for session rule report.

In a first aspect of the disclosure, there is provided a method performed by a policy control node. The method may comprise sending a first message comprising a session rule to a session management node. The session rule may comprise one or more policy information elements comprising at least one of Authorized Session-Aggregate Maximum Bit Rate AMBR, or Authorized Default Quality of Service QoS. The method may further comprise receiving a second message from the session management node. The second message may comprise first information indicating at least one operation status of the at least one of the Authorized Session-AMBR, or the Authorized Default QoS information.

In an embodiment, the operation status may comprise at least one of an operation success or an operation failure.

In an embodiment, an operation of a policy information element may comprise at least one of an installation of the policy information element or a modification of the policy information element.

In an embodiment, the Authorized Session-AMBR and the Authorized Default Quality of Service QoS information may be associated with a protocol data unit session.

In an embodiment, the first information may comprise at least one of second information indicating which policy information element in the session rule is operated successfully or third information indicating which policy information element in the session rule is failed to be operated.

In an embodiment, the third information may comprise at least one of a failed list or a session rule failure code.

In an embodiment, the session rule failure code may comprise at least one of a DEFAULT_QOS_MODIFICATION_FAILURE indicating that an enforcement of default quality of service modification is failed or a SESSION_AMBR_MODIFICATION_FAILURE indicating that an enforcement of session aggregate maximum bit rate modification is failed.

In an embodiment, the first message may comprise at least one of a session management policy control update response, a session management policy control notification request message or a session management policy control create response.

In an embodiment, the second message may comprise a session management policy control update request.

In an embodiment, the method may further comprise determining an action based on the first information.

In an embodiment, the policy control node may comprise a policy control function.

In an embodiment, the session management node may comprise at least one of a session management function, or a session management function combined with a packet data network gateway control plane.

In a second aspect of the disclosure, there is provided a method performed by a session management node. The method may comprise receiving a first message comprising a session rule from a policy control node. The session rule may comprise one or more policy information elements comprising at least one of Authorized Session-Aggregate Maximum Bit Rate AMBR, or Authorized Default Quality of Service QoS. The method may further comprise sending a second message to the policy control node. The second message may comprise first information indicating at least one operation status of the at least one of the Authorized Session-AMBR, or the Authorized Default QoS.

In an embodiment, the operation status may comprise at least one of an operation success or an operation failure.

In an embodiment, an operation of a policy information element may comprise at least one of an installation of the policy information element or a modification of the policy information element.

In an embodiment, the Authorized Session-AMBR and the Authorized Default QoS may be associated with a protocol data unit session.

In an embodiment, the first information may comprise at least one of second information indicating which policy information element in the session rule is operated successfully or third information indicating which policy information element in the session rule is failed to be operated.

In an embodiment, the third information may comprise at least one of a failed list or a session rule failure code.

In an embodiment, the session rule failure code may comprise at least one of a DEFAULT_QOS_MODIFICATION_FAILURE indicating that an enforcement of default quality of service modification is failed or a SESSION AMBR MODIFICATION FAILURE indicating that an enforcement of session aggregate maximum bit rate modification is failed.

In an embodiment, the first message may comprise at least one of a session management policy control update response, a session management policy control notification request message or a session management policy control create response.

In an embodiment, the second message may comprise a session management policy control update request.

In an embodiment, the method may further comprise obtaining the at least one operation status of the at least one policy information element.

In an embodiment, the policy control node may comprise a policy control function.

In an embodiment, the session management node may comprise at least one of a session management function, or a session management function combined with a packet data network gateway control plane.

In a third aspect of the disclosure, there is provided a policy control node. The policy control node may comprise a processor and a memory coupled to the processor. Said memory contains instructions executable by said processor. Said policy control node is operative to send a first message comprising a session rule to a session management node. The session rule comprises one or more policy information elements comprising at least one of Authorized Session-Aggregate Maximum Bit Rate AMBR, or Authorized Default Quality of Service QoS. Said policy control node is further operative to receive a second message from the session management node. The second message may comprise first information indicating at least one operation status of the at least one of the Authorized Session-AMBR, or the Authorized Default QoS information. The Authorized Session-AMBR and the Authorized Default Quality of Service QoS information may be associated with a protocol data unit session.

In a fourth aspect of the disclosure, there is provided a session management node. The session management node may comprise a processor and a memory coupled to the processor. Said memory contains instructions executable by said processor. Said session management node is operative to receive a first message comprising a session rule from a policy control node. The session rule comprises one or more policy information elements comprising at least one of Authorized Session-Aggregate Maximum Bit Rate AMBR, or Authorized Default Quality of Service QoS. Said session management node is operative to send a second message to the policy control node. The second message comprises first information indicating at least one operation status of the at least one of the Authorized Session-AMBR, or the Authorized Default QoS information. The Authorized Session-AMBR and the Authorized Default Quality of Service QoS information may be associated with a protocol data unit session.

In a fifth aspect of the disclosure, there is provided a policy control node. The policy control node may comprise a sending module configured to send a first message comprising a session rule to a session management node. The session rule may comprise one or more policy information elements comprising at least one of Authorized Session-Aggregate Maximum Bit Rate AMBR, or Authorized Default Quality of Service QoS. The policy control node may comprise a receiving module configured to receive a second message from the session management node. The second message comprises first information indicating at least one operation status of the at least one of the Authorized Session-AMBR, or the Authorized Default QoS information. The Authorized Session-AMBR and the Authorized Default Quality of Service QoS information may be associated with a protocol data unit session.

In an embodiment, the policy control node may further comprise a determining module configured to determine an action based on the first information.

In a sixth aspect of the disclosure, there is provided a session management node. The session management node may comprise a receiving module configured to receive a first message comprising a session rule from a policy control node. The session rule may comprise one or more policy information elements comprising at least one of Authorized Session-Aggregate Maximum Bit Rate AMBR, or Authorized Default Quality of Service QoS. The session management node may further comprise a sending module configured to send a second message to the policy control node. The second message may comprise first information indicating at least one operation status of the at least one of the Authorized Session-AMBR, or the Authorized Default QoS information. The Authorized Session-AMBR and the Authorized Default Quality of Service QoS information may be associated with a protocol data unit session.

In an embodiment, the session management node may further comprise an obtaining module configured to obtain the at least one operation status of the at least one policy information element.

In a seventh aspect of the disclosure, there is provided a computer-readable storage medium storing instructions which when executed by at least one processor, cause the at least one processor to perform any of the methods according to the first or second aspects of the disclosure.

In an eighth aspect of the disclosure, there is provided a computer program product, comprising instructions which, when executed on at least one processor, cause the at least one processor to perform any of the methods according to the first or second aspects of the disclosure.

Many advantages may be achieved by applying the proposed solution according to embodiments of the present disclosure. In some embodiments herein, it can enable the session management node to send the correct status with the failed parameters and/or successful parameters in the session rule to the policy control node when the policy control node triggers session rule (e.g. including session-AMBR, default QoS, etc.) operation (e.g. modification or installation) and the session rule operation is partial failure. In some embodiments herein, it can enable the policy control node to know which parameter(s) in the session rule is (are) successful and which parameter(s) is (are) failed in the session rule. In some embodiments herein, it can enable the policy control node to take accurate policy according to the session rule report. In some embodiments herein, it can enable the session management node to specify any of the enforcement errors of session rule, and thus allow the policy control node to differentiate the reason for enforcement failure of session rule. In some embodiments herein, it can enable the policy control node to correctly interpret the error situation of session rule and consequently make a correct policy determination. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 schematically shows a high level architecture in the fifth generation network according to an embodiment of the present disclosure;

FIG. 2 schematically shows non-roaming architecture for interworking between 5GS and EPC/E-UTRAN according to an embodiment of the present disclosure;

FIG. 3 shows a flowchart of a method according to an embodiment of the present disclosure;

FIG. 4 shows a flowchart of a method according to another embodiment of the present disclosure;

FIG. 5a shows a flowchart of a method according to another embodiment of the present disclosure;

FIG. 5b shows a flowchart of a method according to another embodiment of the present disclosure;

FIG. 6 shows a flowchart of session rule update from PCF according to an embodiment of the present disclosure;

FIG. 7 is a block diagram showing an apparatus suitable for practicing some embodiments of the disclosure;

FIG. 8a is a block diagram showing a policy control node according to an embodiment of the disclosure; and

FIG. 8b is a block diagram showing a session management node according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G, 6G communication protocols, and/or any other protocols either currently known or to be developed in the future.

The term “network device” or “network node” or “network function” refers to any suitable function which can be implemented in a network entity (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc. For example, the 4G system (such as Long Term Evolution (LTE)) may include MME (Mobile Management Entity), HSS (home subscriber server), Policy and Charging Rules Function (PCRF), Packet Data Network (PDN) Gateway (PGW), PGW control plane (PGW-C), Serving gateway (SGW), SGW control plane (SGW-C), E-UTRAN Node B (eNB), etc. In other embodiments, the network function may comprise different types of NFs for example depending on a specific network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

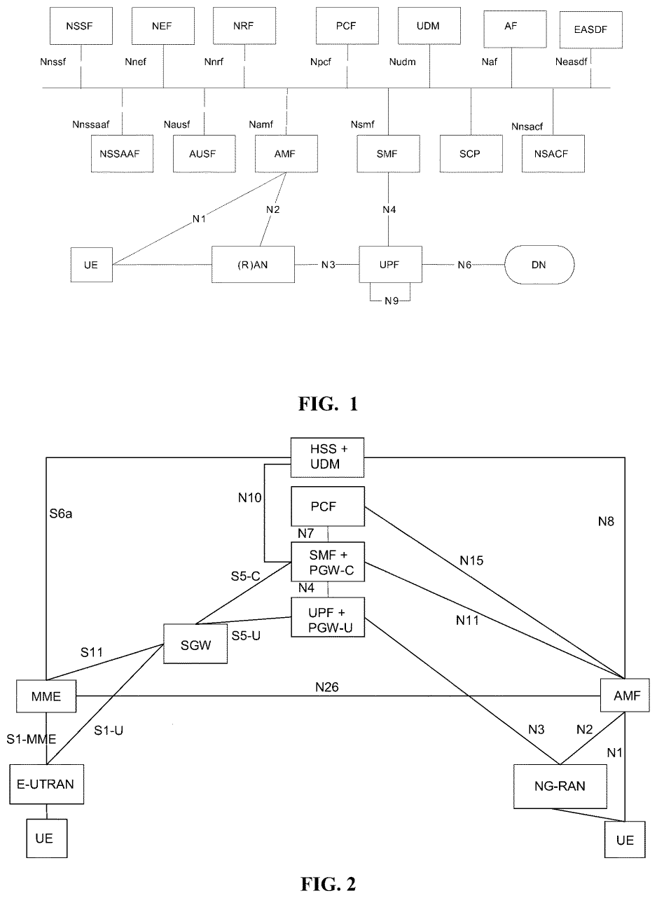

Although the subject matter described herein may be implemented in any appropriate type of system using any suitable components, the embodiments disclosed herein are described in relation to a communication system complied with the exemplary system architecture illustrated in FIGS. 1-2. For simplicity, the system architectures of FIGS. 1-2 only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

FIG. 1 schematically shows a high level architecture in the fifth generation network according to an embodiment of the present disclosure. The architecture of FIG. 1 is same as FIG. 4.2.3-1 of 3GPP TS 23.501 V18.0.0, the disclosure of which is incorporated by reference herein in its entirety. The system architecture of FIG. 1 may comprise some exemplary elements such as AUSF, AMF, DN (data network), NEF, NRF, NSSF, PCF, SMF, UDM, UPF, AF, UE, (R)AN, SCP (Service Communication Proxy), NSSAAF (Network Slice-Specific Authentication and Authorization Function), NSACF (Network Slice Admission Control Function), Edge Application Server Discovery Function (EASDF), etc.

In accordance with an exemplary embodiment, the UE can establish a signaling connection with the AMF over the reference point N1, as illustrated in FIG. 1. This signaling connection may enable NAS (Non-access stratum) signaling exchange between the UE and the core network, comprising a signaling connection between the UE and the (R) AN and the N2 connection for this UE between the (R) AN and the AMF. The (R) AN can communicate with the UPF over the reference point N3. The UE can establish a protocol data unit (PDU) session to the DN (data network, e.g. an operator network or Internet) through the UPF over the reference point N6.

As further illustrated in FIG. 1, the exemplary system architecture also contains the service-based interfaces such as Nnrf, Nnef, Nausf, Nudm, Npcf, Namf, Nnsacf, Neasdf and Nsmf exhibited by NFs such as the NRF, the NEF, the AUSF, the UDM, the PCF, the AMF, the NSACF, the EASDF and the SMF. In addition, FIG. 1 also shows some reference points such as N1, N2, N3, N4, N6 and N9, which can support the interactions between NF services in the NFs. For example, these reference points may be realized through corresponding NF service-based interfaces and by specifying some NF service consumers and providers as well as their interactions in order to perform a particular system procedure.

FIG. 2 schematically shows non-roaming architecture for interworking between 5GS and Evolved Packet Core (EPC)/Evolved Universal Terrestrial Radio Access Network (E-UTRAN) according to an embodiment of the present disclosure, which is same as FIG. 4.3.1-1 of 3GPP TS 23.501 V18.0.0. The system architecture of FIG. 2 may comprise some exemplary elements such as home subscriber server (HSS) combined with UDM (HSS+UDM), UE, E-UTRAN, Mobile Management Entity (MME), Serving Gateway (SGW), SMF combined with Packet Data Network (PDN) Gateway (PGW) control plane (PGW-C) (SMF+PGW-C), UPF combined with PGW user plane (UPF+PGW-U), PCF, AMF, next generation (NG) RAN (NG-RAN), etc.

N26 interface is an inter-core network (CN) interface between the MME and 5GS AMF in order to enable interworking between EPC and the NG core. Support of N26 interface in the network is optional for interworking. N26 supports subset of the functionalities (essential for interworking) that are supported over S10.

PGW-C+SMF and UPF+PGW-U are dedicated for interworking between 5GS and EPC, which are optional and are based on UE Mobility Management (MM) Core Network Capability and UE subscription. UEs that are not subject to 5GS and EPC interworking may be served by entities not dedicated for interworking, i.e. by either by PGW or SMF/UPF.

There can be another UPF (not shown in the FIG. 2 between the NG-RAN and the UPF+PGW-U, i.e. the UPF+PGW-U can support N9 towards an additional UPF, if needed.

Figures and procedures that depict an SGW make no assumption whether the SGW is deployed as a monolithic SGW or as an SGW split into its control-plane and user-plane functionality.

The network elements and interfaces as shown in FIG. 2 may be same as the corresponding network elements and interfaces as described in 3GPP TS 23.501 V18.0.0.

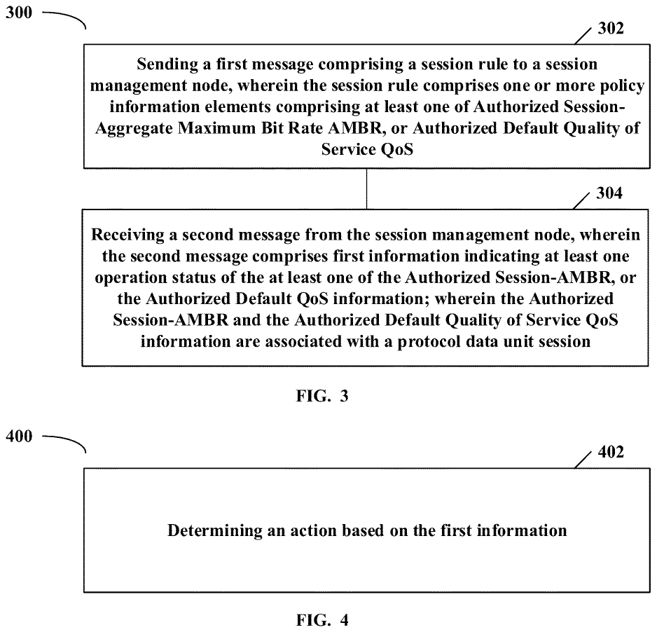

FIG. 3 shows a flowchart of a method according to an embodiment of the present disclosure, which may be performed by an apparatus implemented in/as or communicatively coupled to a policy control node. As such, the apparatus may provide means for accomplishing various parts of the method 300 as well as means for accomplishing other processes in conjunction with other components.

At block 302, the policy control node may send a first message comprising a session rule to a session management node. The session rule may comprise one or more policy information elements. The one or more policy information elements may comprise at least one of Authorized Session-Aggregate Maximum Bit Rate AMBR, or Authorized Default Quality of Service QoS.

The policy control node may be any suitable node or entity or function which can provide policy control function. In an embodiment, the policy control node may be PCF as described in 3GPP TS 23.501 V18.0.0.

In an embodiment, the session management node may be any suitable node or entity or function which can provide session management function. In an embodiment, the session management node may be session management function (SMF) as described in 3GPP TS 23.501 V18.0.0. In another embodiment, the session management node may be a session management function combined with a packet data network gateway control plane (SMF+PGW-C) as described in 3GPP TS 23.501 V18.0.0.

The first message may be any suitable message. In an embodiment, the first message may comprise at least one of a session management (SM) policy control update response, a session management policy control notification request message, or a session management policy control create response. For example, the session management policy control update response, the session management policy control notification request message, or the session management policy control create response may be e same or similar as/to Npcf_SMPolicyControl_Update Response, Npcf_SMPolicyControlNotification Request message or Npcf_SMPolicyControl_Create Response as described in 3GPP TS 23.502 V18.0.0 or 3GPP TS 29.512 V18.1.0.

The policy control node may send the first message to the session management node in various ways. For example, the session management node may send a SM policy control create request to create an SM policy association with the policy control node to receive the policy for a PDU session. The session management node may a SM policy control update request to update the SM policy association with the PCF to receive the updated policy when policy control request trigger(s) condition is met. The policy control node may send a SM policy control update notify to update and/or delete PDU session related policy context at the session management node to the session management node. In these cases, the policy control node may send the first message to the session management node.

The session rule may be any suitable session rule for example as described in various 3GPP specifications such as 3GPP TS 23.502 V18.0.0 or 3GPP TS 29.512 V18.1.0.

The session rule may include any suitable policy information element for example as described in various 3GPP specifications such as 3GPP TS 23.502 V18.0.0 or 3GPP TS 29.512 V18.1.0.

In an embodiment, the one or more policy information elements may comprise at least one of authorized session aggregate maximum bit rate, or authorized default quality of service information, such as Authorized Session-AMBR, Authorized default QoS information as described in 3GPP TS 29.512 V18.1.0.

In an embodiment, the one or more policy information elements may be associated with a protocol data unit session.

In an embodiment, the Authorized Session-AMBR and the Authorized Default Quality of Service QoS information are associated with a protocol data unit session.

At block 304, the policy control node may receive a second message from the session management node. The second message may comprise first information indicating at least one operation status of at least one policy information element in the session rule. The second message may comprise first information indicating at least one operation status of the at least one of the Authorized Session-AMBR, or the Authorized Default QoS information.

In an embodiment, the second message may comprise at least one operation status of at least one policy information element in the session rule.

In an embodiment, the first information may be comprised in a session rule report.

The second message may be any suitable message. In an embodiment, the second message may comprise a session management policy control update request such as Npcf_SMPolicyControl_Update request as described in 3GPP TS 23.502 V18.0.0 or 3GPP TS 29.512 V18.1.0. In another embodiment, the second message may comprise a session management policy control notification response such as Npcf_SMPolicyControlNotification response as described in 3GPP TS 23.502 V18.0.0 or 3GPP TS 29.512 V18.1.0.

An operation of a policy information element may correspond to the operation of the session rule. The operation of the policy information element may comprise any suitable operation such as installation, modification, or deletion. In an embodiment, an operation of a policy information element may comprise at least one of an installation of the policy information element, or a modification of the policy information element.

The operation status may comprise any suitable operation status and the present disclosure has no limit on it. In an embodiment, the operation status may comprise at least one of an operation success or an operation failure.

The first information may be any suitable information and the present disclosure has no limit on it. For example, the first information may be a list, a bitmap, an indication, a flag, etc.

In an embodiment, the first information may comprise at least one of second information indicating which policy information element in the session rule is operated successfully or third information indicating which policy information element in the session rule is failed to be operated. For example, the first information may comprise the second information. The first information may comprise the third information. The first information may comprise both the second information and the third information.

The second information may be any suitable information and the present disclosure has no limit on it. For example, the second information may be a list, a bitmap, an indication, a flag, etc.

The third information may be any suitable information and the present disclosure has no limit on it. For example, the third information and/or the third information may be a list, a bitmap, an indication, a flag, etc.

In an embodiment, the third information may comprise at least one of a failed list or a cause code.

In an embodiment, the third information may comprise at least one of a failed list or a session rule failure code.

The failed list may indicate which parameter(s) (e.g., policy information elements) in the session rule is (are) failed to be installed/modified if a part of the session rule installation/modification is failed.

In an embodiment, each policy information element may have a corresponding cause code. The cause code may be a session rule failure code to indicate that a corresponding policy information element is failed.

In an embodiment, the cause code may comprise at least one of a cause code indicating that an enforcement of default quality of service modification is failed or a cause code indicating that an enforcement of session aggregate maximum bit rate modification is failed.

In an embodiment, the session rule failure code may comprise at least one of a DEFAULT_QOS_MODIFICATION_FAILURE indicating that an enforcement of default quality of service modification is failed or a SESSION AMBR MODIFICATION FAILURE indicating that an enforcement of session aggregate maximum bit rate modification is failed.

For example, the cause code may be DEFAULT_QOS_MODIFICATION_FAILURE which indicates that the enforcement of the default QoS modification has failed. The session management node may use this value to indicate to the policy control node that the default QoS modification has failed. The cause code may be SESSION_AMBR_MODIFICATION_FAILURE which indicates that the enforcement of the session-AMBR modification has failed. The session management node may use this value to indicate to the policy control node that the session-AMBR modification has failed.

FIG. 4 shows a flowchart of a method according to another embodiment of the present disclosure, which may be performed by an apparatus implemented in/as or communicatively coupled to a policy control node. As such, the apparatus may provide means for accomplishing various parts of the method 400 as well as means for accomplishing other processes in conjunction with other components. For some parts which have been described in the above embodiments, the description thereof is omitted here for brevity.

At block 402, the policy control node may determine an action based on the first information.

The action may be any suitable action and the present disclosure has no limit on it.

For example, when the policy control node receives the correct status with the session rule report, the policy control node can decide how to handle this partial failure for example according to a local policy, such as re-sending the policy information element(s) which is (are) failed, roll backing to the old value for the policy information element(s) which is (are) failed or terminating the PDU session if the failure is not allowed.

For example, based on the first information, the policy control node may decide whether retaining, re-installation, modification or removal of the old session rule or old policy information element, or any other action applies.

For example, based on the first information, the policy control node may decide whether retaining the old session rule or old policy information element, re-installation, modification, removal of the session rule or any other action applies.

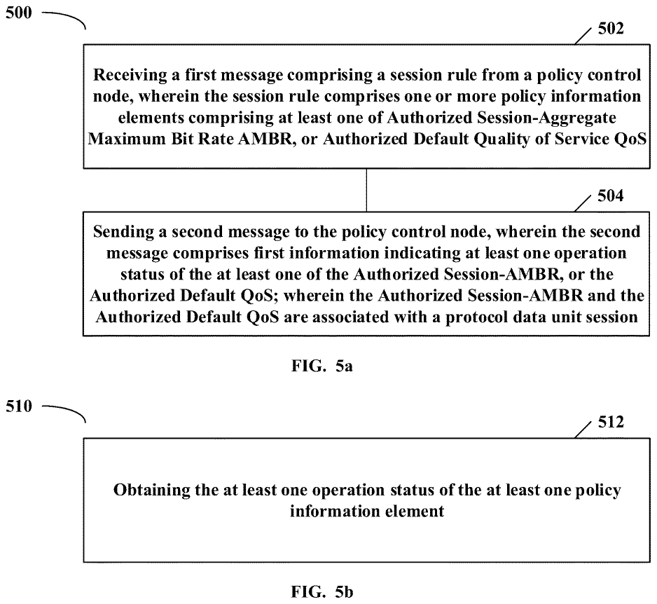

FIG. 5a shows a flowchart of a method according to another embodiment of the present disclosure, which may be performed by an apparatus implemented in/as or communicatively coupled to a session management node. As such, the apparatus may provide means for accomplishing various parts of the method 500 as well as means for accomplishing other processes in conjunction with other components. For some parts which have been described in the above embodiments, the description thereof is omitted here for brevity.

At block 502, the session management node may receive a first message comprising a session rule from a policy control node. The session rule may comprise one or more policy information elements. The session rule may comprise one or more policy information elements may comprise at least one of Authorized Session-Aggregate Maximum Bit Rate AMBR, or Authorized Default Quality of Service QoS.

At block 504, the session management node may send a second message to the policy control node. The second message may comprise first information indicating at least one operation status of at least one policy information element in the session rule. The second message may comprise first information indicating at least one operation status of the at least one of the Authorized Session-AMBR, or the Authorized Default QoS.

In an embodiment, the Authorized Session-AMBR and the Authorized Default QoS may be associated with a protocol data unit session.

In an embodiment, if the session rule report is needed, the session management node may send the second message to the policy control node.

In an embodiment, the operation status may comprise at least one of an operation success or an operation failure.

In an embodiment, an operation of a policy information element may comprise at least one of an installation of the policy information element or a modification of the policy information element.

In an embodiment, the one or more policy information elements may be associated with a protocol data unit session.

In an embodiment, the first information may comprise at least one of second information indicating which policy information element in the session rule is operated successfully or third information indicating which policy information element in the session rule is failed to be operated.

In an embodiment, the third information may comprise at least one of a failed list or a cause code.

In an embodiment, the cause code may comprise at least one of a cause code indicating that an enforcement of default quality of service modification is failed or a cause code indicating that an enforcement of session aggregate maximum bit rate modification is failed.

In an embodiment, the third information may comprise at least one of a failed list or a session rule failure code.

In an embodiment, the session rule failure code may comprise at least one of a DEFAULT_QOS_MODIFICATION_FAILURE indicating that an enforcement of default quality of service modification is failed or a SESSION_AMBR MODIFICATION_FAILURE indicating that an enforcement of session aggregate maximum bit rate modification is failed.

In an embodiment, the one or more policy information elements may comprise at least one of authorized session aggregate maximum bit rate or authorized default quality of service information.

In an embodiment, the first message may comprise at least one of a session management policy control update response, a session management policy control notification request message, or a session management policy control create response.

In an embodiment, the second message may comprise a session management policy control update request.

In an embodiment, the policy control node may comprise a policy control function.

In an embodiment, the session management node may comprise at least one of a session management function, or a session management function combined with a packet data network gateway control plane.

FIG. 5b shows a flowchart of a method according to another embodiment of the present disclosure, which may be performed by an apparatus implemented in/as or communicatively coupled to a session management node. As such, the apparatus may provide means for accomplishing various parts of the method 510 as well as means for accomplishing other processes in conjunction with other components. For some parts which have been described in the above embodiments, the description thereof is omitted here for brevity.

At block 512, the session management node may obtain the at least one operation status of the at least one policy information element.

The session management node may obtain the at least one operation status of the at least one policy information element in various ways and the present disclosure has no limit on it. For example, the session management node may validate of the policy information elements in the session rule, if the validation of a policy information element is unsuccessful, the session management node may reject the policy information element and the operation status of the policy information element may be set as failure. The session management node may obtain the at least one operation status of the at least one policy information element from another network node (such as RAN) or UE. For example, the session management node may send Namf_Communication_NIN2MessageTransfer Request (N1 PDU Session Modification Command, N2 PDU Session Resource Modify Request Transfer) to AMF, and then receive the at least one operation status of the at least one policy information element from RAN or UE via AMF.

For example, if the installation of a policy information element fails, the session management node may set the operation status of the policy information element to failure. Otherwise the session management node may set the operation status of the policy information element to success.

For example, if the modification of a policy information element fails, the session management node may retain the existing policy information element as provisioned without any modification and set the operation status of the policy information element to failure. Otherwise the session management node may set the operation status of the policy information element to success.

For example, the session management node may receive a result from RAN that the default QoS modification is successful, but receive the result from UE that the session-AMBR modification is failed.

For example, the session management node may receive a result from RAN that the default QoS modification is failed, but receive the result from RAN and UE that the session-AMBR modification is successful.

In an embodiment, the session management node such as SMF may report a happen of a partial failure of the session rule to PCF in session rule modification or installation.

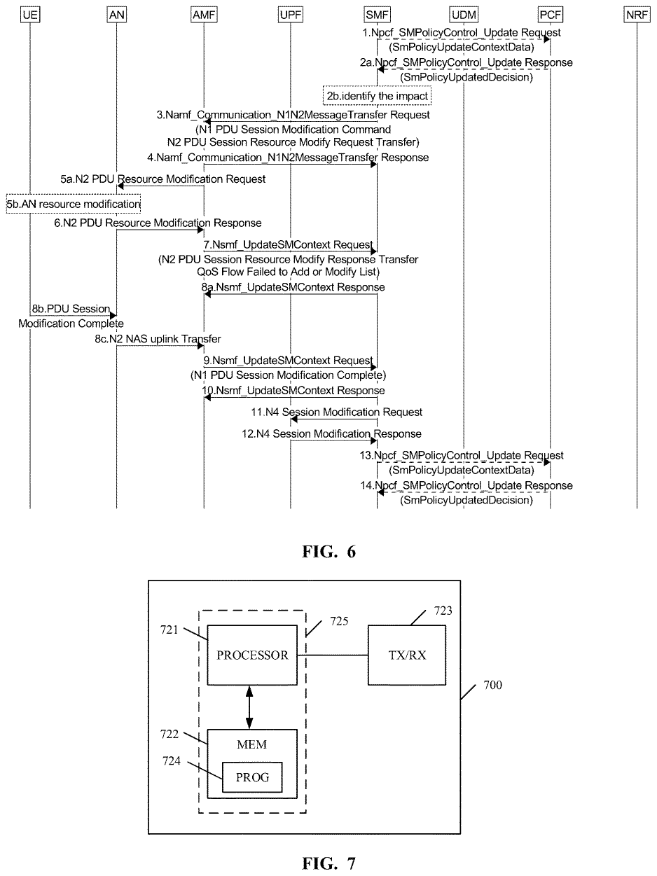

FIG. 6 shows a flowchart of session rule update from PCF according to an embodiment of the present disclosure.

The use case may be as following. RAN or UE returns with partial failure, e.g., session-AMBR is successful, but default QoS modification is failed, or session-AMBR is failed, but default QoS is successful.

Step 1. SMF may send Npcf_SMPolicyControl_Update Request (SmPolicyUpdateContextData) to PCF.

Step 2a. PCF may send Npcf_SMPolicyControl_Update Response (SmPolicyUpdatedDecision) to SMF. For example, PCF may send session rule update or PCF may send a notification to update session rule. The session rule may include a rule identifier, session AMBR, default QoS information (e.g. 5G QoS Identifier (5QI)/allocation and retention priority (ARP)). PCF may send session rule update in the Npcf_SMPolicyControlUpdate Response. Alternatively, PCF may send session rule update in the Npcf_SMPolicyControlNotification Request message to SMF.

Step 2b. SMF may identify the impact.

Step 3. SMF may send Namf_Communication_NIN2MessageTransfer Request (N1 PDU Session Modification Command, N2 PDU Session Resource Modify Request Transfer) to AMF. For example, the authorized default QoS and session AMBR may be sent in N2 message to RAN and N1 message to UE. When SMF receives the update session rule in step 2a, SMF may send the session-AMBR and/or default QoS information to RAN in N2 PDU session resource modify request and to UE in N1 PDU session modification command.

Step 4. AMF may send Namf_Communication_NIN2MessageTransfer Response to SMF.

Step 5a. AMF may send N2 PDU Resource Modification Request to access network (AN).

Step 5b. AN resource modification may be performed between UE and AN.

Step 6. AN may send N2 PDU Resource Modification Response to AMF.

Step 7. AMF may send Nsmf_UpdateSMContext Request (N2 PDU Session Resource Modify Response Transfer QoS Flow Failed to Add or Modify List) to SMF.

Step 8a. SMF may send Nsmf_UpdateSMContext Response to AMF.

Step 8b. UE may send PDU Session Modification Complete to AN.

Step 8c. AN may send N2 Non-Access-Statum (NAS) uplink Transfer to AMF.

Step 9. AMF may send Nsmf_UpdateSMContext Request (N1 PDU Session Modification Complete) to SMF.

For example, when SMF receives default QoS modification which is rejected in step 7, but SMF receives session-AMBR which is accepted in step9, SMF may send session rule report with the indication about the failed default QoS in session rule report to PCF in step 13.

For example, when SMF receives default QoS modification which is accepted in step 7, but session-AMBR is rejected in step 9, SMF may send session rule report with the indication about the failed session-AMBR to PCF in step 13.

For example, SMF may receive the result from RAN in step 7 that the default QoS modification is successful, but receive the result from UE in step 9 that the session-AMBR modification is failed.

For example, SMF may receive the result from RAN in step 7 that the default QoS modification is failed, but receive the result from RAN and UE in step 9 that the session-AMBR modification is successful.

Step 10. SMF may send Nsmf_UpdateSMContext Response to AMF.

Step 11. SMF may send N4 Session Modification Request to UPF.

Step 12. UPF may send N4 Session Modification Response to SMF.

Step 13. SMF may send Npcf_SMPolicyControl_Update Request (SmPolicyUpdateContextData) to PCF.

For example, if the session rule report is needed, SMF can send the correct modification result to PCF in Npcf_SMPolicyControl_Update Request with the session rule report. The session rule report may/should contain the information indicating which parameter is modified successfully and which parameter is failed to be modified in the session rule report. When PCF receives the correct status with the session rule report, PCF can decide how to handle the partial failure for example according to a local policy, such as re-sending the parameters which is failed, rolling back to the old value for the parameters which is failed or terminating the PDU session if the failure is not allowed.

Step 14. PCF may send Npcf_SMPolicyControl_Update Response (SmPolicyUpdatedDecision) to SMF.

In an embodiment, the proposed solution can work for both 5G PDU session and other access such as LTE.

In an embodiment, except the session rule modification, the proposed solution can work for session rule installation during session setup but partial failure happens during installation. In that scenario, the session rule may be included in the Npcf_SMPolicyControlCreate_Response.

Some messages of FIG. 6 may be same as the corresponding messages as described in various 3GPP specifications such as 3GPP TS 23.502 V18.0.0 and 3GPP TS 29.512 V18.1.0. Some messages (such as step 13) of FIG. 6 are enhanced according to some embodiments of the present disclosure.

In an embodiment, Table 5.6.2.37-1 of 3GPP TS 29.512 V18.1.0 may be amended as following. It is noted that in addition to failedList, other attribute name with the similar/same meanings may also be used.

TABLE 5.6.2.37-1
Definition of type SessionRuleReport

| | | | | | |
|---|---|---|---|---|---|
| Attribute name | Data type | P | Cardinality | Description | Applicability |

| | | | | |
|---|---|---|---|---|
| ruleIds | array(string) | M | 1 . . . N | Contains the identifier of the |
| | | | | affected session rule(s). |
| ruleStatus | RuleStatus | M | 1 | Indicates the status of the session |
| | | | | rule(s). |
| failedList | | C | 0 . . . N | Indicates which parameters in |
| | | | | session rule are failed to be |
| | | | | installed/modified if part of the |
| | | | | session rule install/modify is failed. |

In an embodiment, Table 5.6.2.37-1 of 3GPP TS 29.512 V18.1.0 may be amended as following.

TABLE 5.6.2.37-1
Definition of type SessionRuleReport

| | | | | | |
|---|---|---|---|---|---|
| Attribute name | Data type | P | Cardinality | Description | Applicability |

| | | | | |
|---|---|---|---|---|
| ruleIds | array(string) | M | 1 . . . N | Contains the |
| | | | | identifier of the |
| | | | | affected session |
| | | | | rule(s). |
| ruleStatus | RuleStatus | M | 1 | Indicates the status of |
| | | | | the session rule(s). |
| sessRuleFailureCode | SessionRuleFailureCode | C | 0 . . . 1 | Indicates the reason |
| | Add a specific cause | | | that the session |
| | code in | | | rule(s) is being |
| | sessRuleFailureCode to | | | reported. It shall be |
| | indicate policy | | | included when the |
| | information element | | | NF service consumer |
| | (e.g. default QoS) | | | reports the |
| | operation (e.g. | | | enforcement failure |
| | modification or | | | of the session rule(s). |
| | installation) is failed. | | | |

In an embodiment, Table 5.6.3.17-1 of 3GPP TS 29.512 V18.1.0 may be amended as following. It is noted that in addition to DEFAULT_QOS_MODIFICATION_FAILURE and SESSION_AMBR_MODIFICATION_FAILURE, other enumeration value with the similar/same meanings may also be used.

TABLE 5.6.3.17-1
Enumeration SessionRuleFailureCode

| Enumeration value | Description | Applicability |
|---|---|---|
| NF_MAL | Indicates that the session rule could not be successfully | |
| | installed) or enforced (for those already successfully | |
| | installed) due to SMF/UPF malfunction. | |
| RES_LIM | Indicates that the session rule could not be successfully | |
| | installed or enforced (for those already successfully | |
| | installed) due to a limitation of resources at the | |
| | SMF/UPF. | |
| SESSION_RESOURCE_AL- | Indicates the session rule could not be successfully | |
| LOCATION_FAILURE | enforced due to failure during the allocation of | |
| | resources for the PDU session in the UE, RAN or | |
| | AMF. | |
| UNSUCC_QOS_VAL | Indicates that the QoS validation has failed. | |
| INCORRECT_UM | The usage monitoring data of the enforced session rule | (NOTE) |
| | is not the same for all the provisioned session rule(s), | |
| | i.e., the reference identifier to a UsageMonitoringData | |
| | policy decision is not homogeneously provisioned in | |
| | all session rules (e.g., some, but not all, session rules | |
| | contain usage monitoring data, or all session rules | |
| | contain usage monitoring data, but with different | |
| | monitoring key). | |
| UE_STA_SUSP | Indicates that the UE is in suspend state. Only | PolicyUpdateWhenUESuspends |
| | applicable to the interworking scenario as defined in | |
| | Annex B. | |
| UNKNOWN_REF_ID | Indicates that the session rule could not be successfully | |
| | installed/modified because the reference identifier to a | |
| | Policy Decision Data or to a Condition Data is | |
| | unknown to the NF service consumer. | |
| INCORRECT_COND_DATA | Indicates that the session rule could not be successfully | |
| | installed/modified because the referenced Condition | |
| | data are incorrect (e.g. the ConditionData instance | |
| | contains a “deactivationTime” attribute, or the | |
| | “ratType” attribute value in a ConditionData instance | |
| | indicates a RAT type (e.g. “NR”) that is not specified | |
| | for the the “accessType” attribute indicated value (e.g. | |
| | “NON_3GPP_ACCESS”). | |
| REF_ID_COLLISION | Indicates that the session rule could not be successfully | |
| | installed/modified because the same Policy Decision is | |
| | referenced by a PCC rule (e.g. the session rule and the | |
| | PCC rule refer to the same Usage Monitoring decision | |
| | data). | |
| DEFAULT_QOS_MOD- | Indicates that the enforcement of the default QoS | |
| IFICATION_FAILURE | modification failed. The SMF shall use this value to | |
| | indicate to the PCF that the default QoS modification | |
| | has failed. | |
| SESSION_AMBR_MOD_{—} | Indicates that the enforcement of the session-AMBR | |
| IFICATION_FAILURE | modification failed. The SMF shall use this value to | |
| | indicate to the PCF that the session-AMBR | |
| | modification has failed. | |

(NOTE):
The “INCORRECT_UM” value shall only be used when the feature “UMC” is supported.

In an embodiment, A.2 of 3GPP TS 29.512 V18.1.0 may be amended as following.

A.2 NPCF_SMPOLICYCONTROL API
.....text is is omitted here for brevity......
SessionRuleFailureCode:
anyOf:

| | |
|---|---|
| - | type: string |
| | enum: |

| | |
|---|---|
| - | NF_MAL |
| - | RES_LIM |
| - | SESSION_RESOURCE_ALLOCATION_FAILURE |
| - | UNSUCC_QOS_VAL |
| - | INCORRECT_UM |
| - | UE_STA_SUSP |
| - | UNKNOWN_REF_ID |
| - | INCORRECT_COND_DATA |
| - | REF_ID_COLLISION |
| - | AN_GW_FAILED |
| - | DEFAULT_QOS_MODIFICATION_FAILURE |
| - | SESSION_AMBR_MODIFICATION_FAILURE |

| | |
|---|---|
| - | type: string |
| | description: > |

```
  This string provides forward-compatibility with future
  extensions to the enumeration and is not used to encode
  content defined in the present version of this API.
```

description: |

| Indicates the reason of the session rule failure. | |
|---|---|
| Possible values are | |
| - | NF_MAL: Indicates that the PCC rule could not be successfully installed (for those |

provisioned from the PCF) or activated (for those pre-defined in SMF) or enforced

(for those

| already successfully installed) due to SMF/UPF malfunction. | |
|---|---|
| - | RES_LIM: Indicates that the PCC rule could not be successfully installed (for those |

provisioned from PCF) or activated (for those pre-defined in SMF) or enforced (for

those

| already successfully installed) due to a limitation of resources at the SMF/UPF. | |
|---|---|
| - | SESSION_RESOURCE_ALLOCATION_FAILURE: Indicates the session rule |

could not be successfully

enforced due to failure during the allocation of resources for the PDU session in the

UE,

| RAN or AMF. | |
|---|---|
| - | UNSUCC_QOS_VAL: indicates that the QoS validation has failed. |
| - | INCORRECT_UM: The usage monitoring data of the enforced session rule is not the |

same for

| all the provisioned session rule(s). | |
|---|---|
| - | UE_STA_SUSP: Indicates that the UE is in suspend state. |
| - | UNKNOWN_REF_ID: Indicates that the session rule could not be successfully |
| installed/modified because the referenced identifier to a Policy Decision Data or to a | |
| Condition Data is unknown to the SMF. | |
| - | INCORRECT_COND_DATA: Indicates that the session rule could not be |

successfully

| installed/modified because the referenced Condition data are incorrect. | |
|---|---|
| - | REF_ID_COLLISION: Indicates that the session rule could not be successfully |

installed/modified because the same Policy Decision is referenced by a PCC rule (e.g.

the

| session rule and the PCC rule refer to the same Usage Monitoring decision data). | |
|---|---|
| - | AN_GW_FAILED: Indicates that the AN-Gateway has failed and that the PCF |

should refrain

```
  from sending policy decisions to the SMF until it is informed that the S-GW has been
  recovered. This value shall not be used if the SM Policy association modification
```

procedure

| is initiated for session rule removal only. | |
|---|---|
| - | DEFAULT_QOS_MODIFICATION_FAILURE: Indicates that the enforcement of |

the default QoS

modification failed. The SMF shall use this value to indicate to the PCF that the

default

| QoS modification has failed. | |
|---|---|
| - | SESSION_AMBR_MODIFICATION_FAILURE: Indicates that the enforcement of |

the session-AMBR

```
  modification failed. The SMF shall use this value to indicate to the PCF that the
  session-AMBR modification has failed.
```

......text is omitted here for brevity......

Many advantages may be achieved by applying the proposed solution according to embodiments of the present disclosure. In some embodiments herein, it can enable the session management node to send the correct status with the failed parameters and/or successful parameters in the session rule to the policy control node when the policy control node triggers session rule (e.g. including session-AMBR, default QoS, etc.) operation (e.g. modification or installation) and the session rule operation is partial failure. In some embodiments herein, it can enable the policy control node to know which parameter(s) in the session rule is (are) successful and which parameter(s) is (are) failed in the session rule. In some embodiments herein, it can enable the policy control node to take accurate policy according to the session rule report. In some embodiments herein, it can enable the session management node to specify any of the enforcement errors of session rule, and thus allow the policy control node to differentiate the reason for enforcement failure of session rule. In some embodiments herein, it can enable the policy control node to correctly interpret the error situation of session rule and consequently make a correct policy determination. The embodiments herein are not limited to the features and advantages mentioned above. A person skilled in the art will recognize additional features and advantages upon reading the following detailed description.

FIG. 7 is a block diagram showing an apparatus suitable for practicing some embodiments of the disclosure. For example, the policy control node or the session management node described above may be implemented as or through the apparatus 700.

The apparatus 700 may comprise at least one processor 721, such as a digital processor (DP), and at least one memory (MEM) 722 coupled to the processor 721. The apparatus 700 may further comprise a transmitter TX and receiver RX 723 coupled to the processor 721. The MEM 722 stores a program (PROG) 724. The PROG 724 may include instructions that, when executed on the associated processor 721, enable the apparatus 700 to operate in accordance with the embodiments of the present disclosure. A combination of the at least one processor 721 and the at least one MEM 722 may form processing means 725 adapted to implement various embodiments of the present disclosure.

Various embodiments of the present disclosure may be implemented by computer program executable by one or more of the processor 721, software, firmware, hardware or in a combination thereof.

The MEM 722 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 721 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the policy control node, the memory 722 contains instructions executable by the processor 721, whereby the policy control node operates according to any of the methods performed by the policy control node as described above.

In an embodiment where the apparatus is implemented as or at the session management node, the memory 722 contains instructions executable by the processor 721, whereby the session management node operates according to any of the methods performed by the session management node as described above.

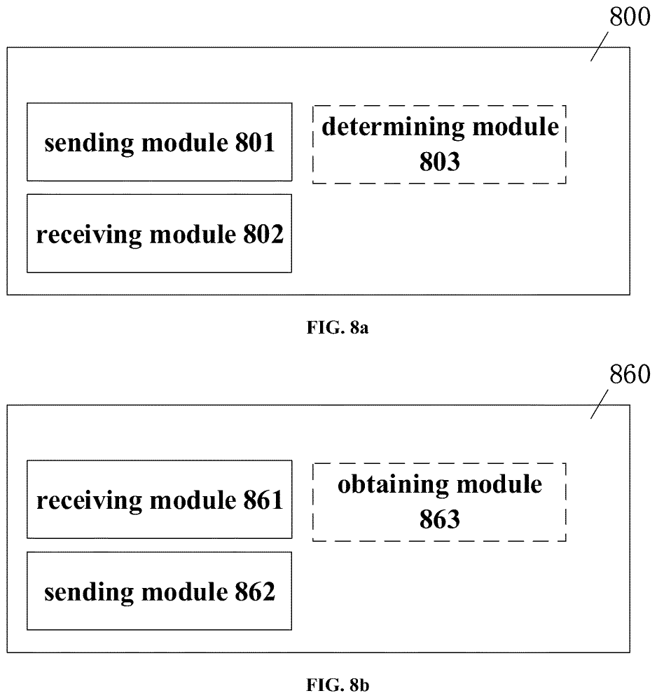

FIG. 8a is a block diagram showing a policy control node according to an embodiment of the disclosure. As shown, the policy control node 800 may comprise a sending module 801 configured to send a first message comprising a session rule to a session management node. The session rule may comprise one or more policy information elements comprising at least one of Authorized Session-Aggregate Maximum Bit Rate AMBR, or Authorized Default Quality of Service QoS. The policy control node 800 may comprise a receiving module 802 configured to receive a second message from the session management node. The second message comprises first information indicating at least one operation status of the at least one of the Authorized Session-AMBR, or the Authorized Default QoS information. The Authorized Session-AMBR and the Authorized Default Quality of Service QoS information may be associated with a protocol data unit session.

In an embodiment, the policy control node 800 may further comprise a determining module 803 configured to determine an action based on the first information.

FIG. 8b is a block diagram showing a session management node according to an embodiment of the disclosure. As shown, the session management node 860 may comprise a receiving module 861 configured to receive a first message comprising a session rule from a policy control node. The session rule may comprise one or more policy information elements comprising at least one of Authorized Session-Aggregate Maximum Bit Rate AMBR, or Authorized Default Quality of Service QoS. The session management node 860 may further comprise a sending module 862 configured to send a second message to the policy control node. The second message may comprise first information indicating at least one operation status of the at least one of the Authorized Session-AMBR, or the Authorized Default QoS information. The Authorized Session-AMBR and the Authorized Default Quality of Service QoS information may be associated with a protocol data unit session.

In an embodiment, the session management node 860 may further comprise an obtaining module 863 configured to obtain the at least one operation status of the at least one policy information element.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the policy control node or the session management node may not need a fixed processor or memory, any computing resource and storage resource may be arranged from the policy control node or the session management node in the communication system. The introduction of virtualization technology and network computing technology may improve the usage efficiency of the network resources and the flexibility of the network.

Further, a commutation system may include a host, a terminal device and a network node (such as base station, the policy control node or the session management node). The host may be configured to operate in the communication system to provide an over-the-top (OTT) service.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-28. (canceled)

29. A method performed by a session management node, the method comprising:
receiving from a policy control node a first message comprising a session rule that includes one or more policy information elements (IEs), including at least one of the following policy IEs associated with a protocol data unit (PDU) session: Authorized Session-Aggregate Maximum Bit Rate (AMBR), and Authorized Default Quality of Service (QoS); and
sending a second message to the policy control node, wherein the second message includes first information indicating operation status of the at least one policy IEs associated with the PDU session.

30. The method according to claim 29, wherein each indicated operation status is one of the following: an operation success, or an operation failure.

31. The method according to claim 29, wherein each indicated operation status relates to one of the following operations on one of the policy IEs: an installation of the policy IE, or a modification of the policy IE.

32. The method according to claim 29, wherein the first information comprises at least one of the following:
second information indicating the policy IEs, in the session rule, for which an operation was successful, and
third information indicating the policy IEs, in the session rule, for which an operation failed.

33. The method according to claim 32, wherein the third information comprises at least one of the following: a failed list, and one or more session rule failure codes.

34. The method according to claim 33, wherein the one or more session rule failure codes include at least one of the following:
a DEFAULT_QOS_MODIFICATION_FAILURE indicating that an enforcement of default quality of service modification has failed, and
a SESSION_AMBR_MODIFICATION_FAILURE indicating that an enforcement of session aggregate maximum bit rate modification has failed.

35. The method according to claim 29, wherein the first message is one of the following:
a session management policy control update response,
a session management policy control notification request message, or
a session management policy control create response.

36. The method according to claim 29, wherein the second message is a session management policy control update request.

37. The method according to claim 29, further comprising obtaining at least one of the following operation status:
operation status of enforcement of the Authorized Session-AMBR in a User Equipment, and
operation status of enforcement of the Authorized Default QoS in a Radio Access Network,
wherein the obtained operation status is included in the first information sent to the policy control node.

38. The method according to claim 29, wherein one or more of the following applies:
the policy control node comprises a policy control function of a fifth-generation core network (5GC); and
the session management node is one of the following:
a session management function of the 5GC, or
the session management function combined with a packet data network gateway control plane of an evolved packet core network (EPC).

39. A session management node comprising:
a processor; and
a memory operably coupled to the processor and having stored therein instructions that, when executed by the processor, configure the session management node to:
receive from a policy control node a first message comprising a session rule that includes one or more policy information elements (IEs), including at least one of the following policy IEs associated with a protocol data unit (PDU) session: Authorized Session-Aggregate Maximum Bit Rate (AMBR), and Authorized Default Quality of Service (QOS); and
send a second message to the policy control node, wherein the second message includes first information indicating operation status of the at least one policy IEs associated with the PDU session.

40. The session management node according to claim 39, wherein each indicated operation status is one of the following: an operation success, or an operation failure.

41. The session management node according to claim 39, wherein each indicated operation status relates to one of the following operations on one of the policy IEs: an installation of the policy IE, or a modification of the policy IE.

42. The session management node according to claim 39, wherein the first information comprises at least one of the following:
second information indicating the policy IEs, in the session rule, for which an operation was successful, and
third information indicating the policy IEs, in the session rule, for which an operation failed.

43. The session management node according to claim 42, wherein the third information comprises at least one of the following: a failed list, and one or more session rule failure codes.

44. The session management node according to claim 43, wherein the one or more session rule failure codes include at least one of the following:
a DEFAULT_QOS_MODIFICATION_FAILURE indicating that an enforcement of default quality of service modification has failed, and
a SESSION_AMBR_MODIFICATION_FAILURE indicating that an enforcement of session aggregate maximum bit rate modification has failed.

45. The session management node according to claim 39, wherein the first message is one of the following:
a session management policy control update response,
a session management policy control notification request message, or
a session management policy control create response.

46. The session management node according to claim 39, wherein the second message is a session management policy control update request.

47. The session management node according to claim 39, wherein execution of the instructions by the processor further configures the session management node to obtain at least one of the following operation status:
operation status of enforcement of the Authorized Session-AMBR in a User Equipment, and
operation status of enforcement of the Authorized Default QoS in a Radio Access Network,
wherein the obtained operation status is included in the first information sent to the policy control node.
